(19) United States
(12) Patent Application Publication
(10) Pub. No.: US 2026/0280681 A1
(43) Pub. Date: Sep. 17, 2026

(54) DETERMINATION OF SERVING BEAM FOR A USER EQUIPMENT

(71) Applicant: Telefonaktiebolaget LM Ericsson (publ), Stockholm (SE)

(72) Inventors: Anteneh Atumo GEBREMARIAM, Malmo (SE); Magnus HURD, Stockholm (SE); Zhiming YIN, Danderyd (SE); Hong ZHU, Lund (SE)

(21) Appl. No.: 19/168,559

(22) PCT Filed: Mar. 27, 2023
(86) PCT No.: PCT/SE2023/050270

§ 371 Date: Sep. 24, 2025

(51) Int. Cl. H04B 7/08; H04L 5/00; H04W 72/232

(52) U.S. Cl. CPC H04B 7/088; H04L 5/0048; H04W 72/232

(57) ABSTRACT

There is provided techniques for determining a serving beam for a UE. A method is performed by a network node. The method comprises triggering the UE to perform an uplink transmission that comprises a demodulation reference signal (DM-RS). The method comprises receiving, in a set of beams, the DM-RS from the UE. The method comprises determining, based on channel state measurements performed by the network node on the DM-RS as received in the set of beams, which beam in the set of beams to use as the serving beam for the UE.

### TECHNICAL FIELD

Embodiments presented herein relate to a method, a network node, a computer program, and a computer program product for determining a serving beam for a user equipment.

### BACKGROUND

In general terms, high band deployment is according to the third generation partnership project (3GPP) referred to as deployment of wireless communication on frequencies higher than 6 GHz. To cope with coverage challenges at such high frequencies, more antenna elements are needed. In new radio (NR) type telecommunication systems, the notion of massive antenna arrays has been introduced to achieve both increased coverage and increased level of throughput. These antenna arrays are sometimes referred to as Advanced Antenna Systems (AAS). According to 3GPP, an AAS is a defined collection of antenna elements, such as a panel of antenna elements, and is referred to as a transmission and reception point (TRP).

Analog beamforming can be used to reduce the cost of TRPs. Analog beamforming might also be used by the user equipment (UE) for such high band deployments. Analog beamforming means that transmission and reception can only be performed in one beam at a time. This is since the spatial transmission or reception filter applies to all resource elements of an orthogonal frequency-division multiplexing (OFDM) symbol (per polarization). Analog beamforming can therefore be regarded as an example of time-domain beamforming, meaning that one beamform applies to all frequency resources being part of one transmission.

Hybrid beamforming, based on different sub-arrays of antenna elements connected to separate radio-frequency (RF) chains is another type of time-domain beamforming. Compared to strict digital beamforming, hybrid beamforming can be regarded as in the digital domain operating on an array of subarrays of antenna elements, as shown in FIG. 1. FIG. 1(a) is a front view of an AAS 240. The AAS 240 comprises a number of antenna panels, or antenna arrays, 242. Each antenna panel, or antenna array, 242 comprises one or more subarrays 244. In turn, each subarray is composed of one or more individual antenna elements 246. In the illustrative example of FIG. 1, the AAS 240 comprises 64 antenna elements in total, divided into 16 subarrays 244 in four panels, or antenna arrays, 242. FIG. 1(b) is a side view of the AAS 240. The AAS 240 is configured for analog beamforming, and two directions induced by analog beamforming for four of the subarrays are illustrated at reference numerals 270 and 280. As further illustrated, the AAS 240 is operatively connected, over an interface 260, to a digital beamforming module 250. FIG. 1 thus shows an example of hybrid beamforming, where each (analog) subarray is, over the interface 260, connected to a digital processing chain in the digital beamforming module 250. The subarrays of antenna elements are subject to analog beamforming and act as physical antenna elements, except that the beamforms of the subarrays, as given appropriate weights by means of analog beamforming, can each be pointing into different directions for a specific point in time. These sub-arrays might therefore be referred to as analog antenna subarrays.

Assuming one of the analog beams in FIG. 1, there is an option of digital beamforming. The case of no analog beamforming can be seen as there is simply only one direction available in FIG. 1. The digital beamforming may introduce a Grid of Beams (GoB), both in horizontal and vertical dimension.

In terms of beam management, the gNB, or other type of network node at the network side, would track the UE to select both a direction as induced by analog beamforming and a digital beam in the GoB for transmission/reception to/from the UE. According to a first example, this can be accomplished by having the UE is measuring on downlink reference signals, such as channel state information reference signals (CSI-RS) transmitted by the network node and reporting these measurements back to the network node in a channel state information (CSI) report. According to a second example, this can be accomplished by having the UE transmitting reference signals, such as Sounding Reference Signals (SRS), that the network node performs measurements on.

For the first example, the network node configures several one-port CSI-RS resources, as in 3GPP TS 38.211 “NR; Physical channels and modulation”, version 17.4.0. Each such CSI-RS resource is transmitted on a candidate beam (such as one of the beams in the GoB, assuming one of the possible directions induced by analog beamforming). The UE then measures the received power on each CSI-RS resource and reports back to the network node accordingly. Typically, only a subset of all the beams of the GoB is being considered as candidate beams. When a candidate beam is reported to have power high enough compared to current beam, the network node would promote this candidate beam to be the current beam to be used for upcoming transmission/reception for this particular UE.

For the second example, the network configures SRS resources, as in aforementioned 3GPP TS 38.211, for transmission by the UE in the uplink. The network node allocates SRS resources individually for each UE, based on physical resource blocks (PRBs), transmission comb and cyclic shift. The SRS resources assigned to one UE are orthogonal to the SRS resources assigned to another UE. The network node, upon reception of the SRS resources, analyses how much power of the sounding from the UE is received in each beam of the GoB. The most dominant beam(s) can be selected to be used for upcoming transmission/reception for this particular UE.

Compared to full digital beamforming, hybrid beamforming reduces the need to transfer data between the frontend and the baseband. Another option to reduce the data transfer between baseband and frontend is to limit the number of (transmission) layers allowed at a specific time occasion. A yet further option is to use a digital receiver receiving data from all the analog antenna subarrays but on only a fraction of the resource elements in scope of the deployment. For the latter it could be that the receiver is configured to only receive in a limited bandwidth over some symbols (typically enough symbols to capture a full slot). Such a digital receiver is hereinafter referred to as a Narrowband Receiver (NBR). Whereas the use of such a narrowband receiver disregards from frequency-related information from the full bandwidth, it still allows the network node to spatially resolve the received signal from the grid of all the analog antenna subarrays elements (on a reduced bandwidth), assuming a certain direction induced by analog beamforming.

One issue with the above disclosed first example (i.e., the CSI-RS based approach) is that beam tracking based on CSI-RS is costly since one CSI-RS resource is needed per candidate beam and UE.

One issue with the above disclosed second example (i.e., the SRS based approach) is that some UEs might not support sounding.

Hence, there is still a need for improved beam management.

### SUMMARY

An object of embodiments herein is to provide efficient beam management where the above issues are avoided, or at least mitigated.

One particular object is to provide beam management that is less costly than the above disclosed first example (i.e., the CSI-RS based approach).

Another particular object is to provide beam management that can be applied also for UEs that do not support sounding (i.e., for UEs that do not support the SRS based approach).

According to a first aspect there is presented a method for determining a serving beam for a UE. The method is performed by a network node. The method comprises triggering the UE to perform an uplink transmission that comprises a demodulation reference signal (DM-RS). The method comprises receiving, in a set of beams, the DM-RS from the UE. The method comprises determining, based on channel state measurements performed by the network node on the DM-RS as received in the set of beams, which beam in the set of beams to use as the serving beam for the UE.

According to a second aspect there is presented a network node for determining a serving beam for a UE. The network node comprises processing circuitry. The processing circuitry is configured to cause the network node to trigger the UE to perform an uplink transmission that comprises a DM-RS. The processing circuitry is configured to cause the network node to receive, in a set of beams, the DM-RS from the UE. The processing circuitry is configured to cause the network node to determine, based on channel state measurements performed by the network node on the DM-RS as received in the set of beams, which beam in the set of beams to use as the serving beam for the UE.

According to a third aspect there is presented a network node for determining a serving beam for a UE. The network node comprises a trigger module configured to trigger the UE to perform an uplink transmission that comprises a DM-RS. The network node comprises a receive module configured to receive, in a set of beams, the DM-RS from the UE. The network node comprises a determine module configured to determine, based on channel state measurements performed by the network node on the DM-RS as received in the set of beams, which beam in the set of beams to use as the serving beam for the UE.

According to a fourth aspect there is presented a computer program for determining a serving beam for a UE. The computer program comprises computer code which, when run on processing circuitry of a network node, causes the network node to perform actions. One action comprises the network node to trigger the UE to perform an uplink transmission that comprises a DM-RS. One action comprises the network node to receive, in a set of beams, the DM-RS from the UE. One action comprises the network node to determine, based on channel state measurements performed by the network node on the DM-RS as received in the set of beams, which beam in the set of beams to use as the serving beam for the UE.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects provide efficient beam management where the above issues are avoided.

Advantageously, these aspects provide beam management that is less costly than the above disclosed first example.

Advantageously, these aspects provide beam management that can be applied also for UEs that do not support sounding.

Advantageously, these aspects allow the network node to use a narrowband receiver when the beam management is performed.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 schematically illustrates an AAS according to an embodiment;

FIG. 2 is a schematic diagram illustrating a communications network according to embodiments;

FIG. 3 is a flowchart of methods according to embodiments;

FIGS. 4 and 5 schematically illustrate time/frequency grids according to embodiments;

FIG. 6 schematically illustrates examples of BWPs according to embodiments;

FIG. 7 schematically illustrates 14 OFDM symbols according to an embodiment;

FIG. 8 is a signaling diagram according to an embodiment;

FIG. 9 is a schematic diagram showing functional units of a network node according to an embodiment;

FIG. 10 is a schematic diagram showing functional modules of a network node according to an embodiment; and

FIG. 11 shows one example of a computer program product comprising computer readable storage medium according to an embodiment.

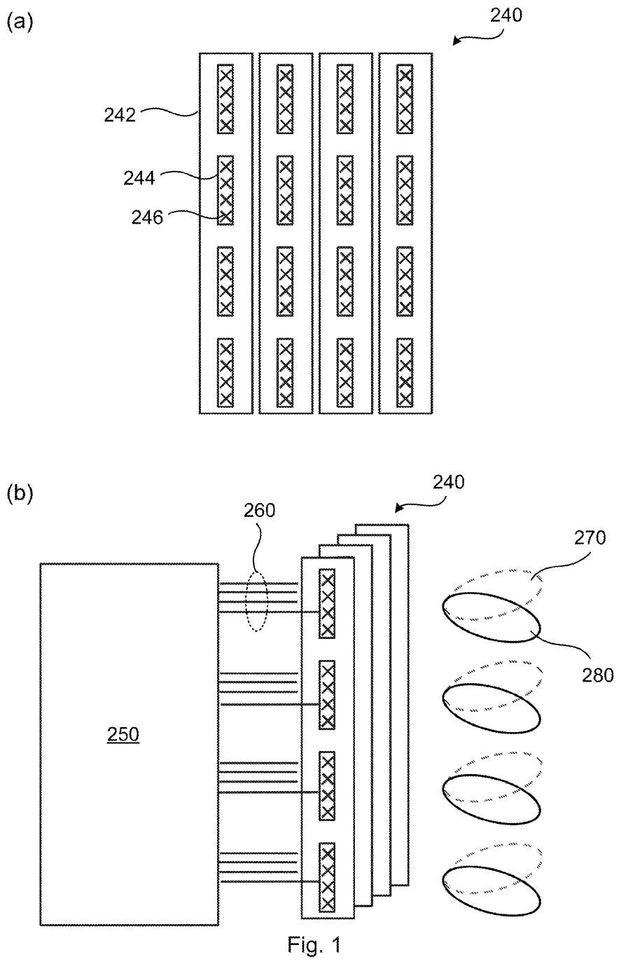

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

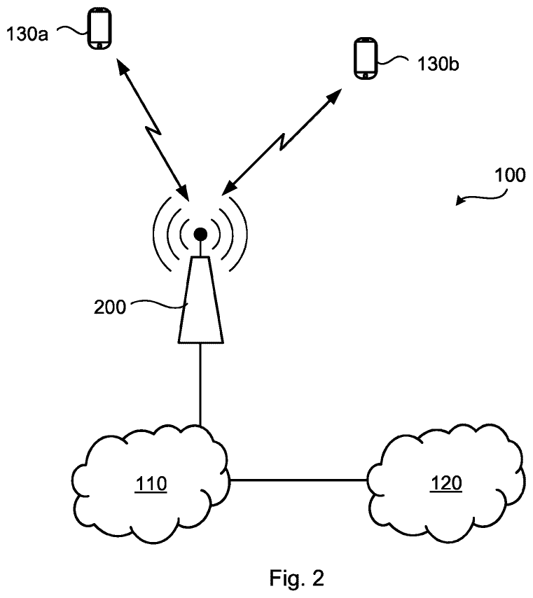

FIG. 2 is a schematic diagram illustrating a communications network 100 where embodiments presented herein can be applied. The communications network 100 could be a third generation (3G) telecommunications network, a fourth generation (4G) telecommunications network, or a fifth (5G) telecommunications network and support any 3GPP telecommunications standard, where applicable.

The communications network 100 comprises a network node 200 configured to provide network access to UEs 130a, 130b. The network node 200 is operatively connected to a core network 110. The core network 110 is in turn operatively connected to a service network 120, such as the Internet. The UEs 130a, 130b are thereby enabled to, via the network node 200, access services of, and exchange data with, the service network 120.

Examples of network nodes 200 are radio access network nodes, radio base stations, base transceiver stations, Node Bs, evolved Node Bs, gNBs, TRPs, access points, access nodes, and integrated access and backhaul nodes. Examples of UEs 130a, 130b are wireless devices, mobile stations, mobile phones, handsets, wireless local loop phones, smartphones, laptop computers, tablet computers, network equipped sensors, network equipped vehicles, and so-called Internet of Things devices.

For illustrative purposes it is assumed that UE 130a least momentarily is incapable of sounding, i.e., to transmit SRSs, whereas UE 130b least momentarily is capable of sounding. Hereinafter, UE 130a might therefore be referred to as a non-sounding UE 130a whereas UE 130b might be referred to as a sounding UE 130b. Whether a given UE 130a, 130b is capable of sounding or not can be communicated from the given UE 130a, 130b to the network node 200 using UE capability signaling, as in 3GPP TS 38.331 “NR; Radio Resource Control (RRC); Protocol specification”, version 17.3.0.

The sounding UE 130b is assumed to be able to transmit SRS in order to indicate CSI to the network node 200. The radio resources, both in time and frequency domain, for SRS are either periodic (using periodic or semi-persistent SRS) or scheduled by the network node 200 based on signaling on a physical downlink control channel (PDCCH) using aperiodic SRS triggered in downlink, uplink, or via a downlink control information (DCI). Details of the SRS resources can be pre-configured via radio resource control (RRC) signaling, see, aforementioned 3GPP TS 38.331. The SRS resources are by the network node 200 used to estimate which beam to be used for upcoming transmission/reception for the sounding UE 130b.

On the other hand, and as will be disclosed hereinafter, the network node 200 will use demodulation reference signals (DM-RSs) as transmitted by the non-sounding UE 130a to estimate which beam to be used for upcoming transmission/reception for the non-sounding UE 130a. As will be further disclosed below, the network node will therefore trigger the non-sounding UE 130a to perform an uplink transmission that comprises DM-RSs.

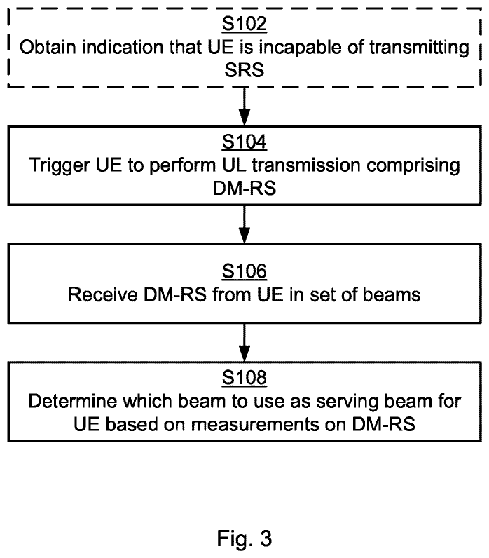

FIG. 3 is a flowchart illustrating embodiments of methods for determining a serving beam for a UE 130a. The methods are performed by the network node 200. The methods are advantageously provided as computer programs 1120.

As disclosed above, for the non-sounding UE 130a, the estimation of which beam to be used to serve the UE 130a is based on DM-RSs. The non-sounding UE 130a therefore needs to be triggered to perform an uplink transmission that comprises at least one DM-RS, as in S104.

S104: The network node 200 triggers the UE 130a to perform an uplink transmission that comprises at least one DM-RS.

The network node 200 then uses different beams to receive the DM-RSs, as in S106.

S106: The network node 200 receives, in a set of beams, the DM-RS from the UE 130a.

The network node 200 then selects the beam in which the DM-RSs were received with highest received power, or some other quality metric, to be used for upcoming transmission/reception for the non-sounding UE 130a, as in S108.

S108: The network node 200 determines, based on channel state measurements performed by the network node 200 on the DM-RS as received in the set of beams, which beam in the set of beams to use as the serving beam for the UE 130a.

Embodiments relating to further details of determining a serving beam for a UE 130a as performed by the network node 200 will now be disclosed with continued reference to FIG. 3.

In some aspects, the network node 200 is explicitly made aware that the UE 130a is a non-sounding UE 130a. Therefore, in some embodiments, the network node 200 is configured to perform (optional) step S102.

S102: The network node 200 obtains an indication that the UE 130a at least momentarily is incapable of transmitting an SRS.

In some examples, the indication is obtained in UE capability signaling from the UE 130a.

In some embodiments, the UE 130a is triggered to periodically perform the uplink transmission that comprises the DM-RS. This periodicity can be changed over time. The network node 200 might indicate a change of the periodicity to the UE 130a using DCI.

In some embodiments, the UE 130a is triggered by dynamic scheduling, provided by the network node 200 via PDCCH signaling, to periodically perform the uplink transmission that comprises the DM-RS.

In some embodiments, the UE 130a is triggered by a configured uplink grant, provided by the network node 200 via RRC signaling, to periodically perform the uplink transmission that comprises the DM-RS.

In some aspects, the UE 130a is triggered to transmit the DM-RS on a using physical uplink shared channel (PUSCH). That is, in some embodiments, the UE 130a is triggered by the network node 200 to transmit the DM-RS using PUSCH signaling. In general terms, PUSCH is a channel used by UEs for transmitting user data in the uplink. In this respect, for the purpose of estimating the beam for the UE 130a, the network node 200 does not need to pay any attention to any such user data. The focus of the network node 200 is rather the DM-RSs of the PUSCH transmission. Therefore, in some aspects, the network node 200 ensures that the UE 130a does not transmit any user data upon the UE 130a having been explicitly triggered to perform an uplink transmission that comprises DM-RSs, as in in S104. That is, in some embodiments, the UE 130a is triggered to perform a transmission of a CSI, report, where the transmission is without user data but comprises the DM-RS. In this case, the network node 200 does not need to decode the payload containing the CSI report. However, in other aspects, the UE 130a is allowed to transmit user data even when the UE 130a has been explicitly triggered to perform an uplink transmission that comprises DM-RSs, as in in S104. That is, in some embodiments, the PUSCH signaling comprises payload, and the network node 200 ignores decoding the payload. However, as will be further disclosed below, the network node 200 might even decode the received payload (e.g., comprising user data or channel state information).

Further aspects of where the network node 200 ensures that the UE 130a does not transmit any user data upon the UE 130a having been explicitly triggered to perform an uplink transmission that comprises DM-RSs will be disclosed next.

In this case the network node 200 needs to trigger the UE 130a to transmit something that does not contain any user data. One example involves triggering the UE 130a to formulate a CSI report for the UE 130a to execute and set the UL-SCH indicator to 0 (according to which no user data would be added, only the report). The network node 200 might then decide to not decode the CSI report (theoretically, the CSI reports or reports from some UEs could be decoded considering uplink multi-user multiple-input multiple-output (MU-MIMO) aspects); the network node 200 might only investigate the DM-RSs to conclude what beam is appropriate. In fact, such CSI reporting can be semi-persistent. Such a simple report could correspond to a specific trigger state in the uplink DCI (as specified in the CSI request field, see 3GPP TS 38.212 “NR; Multiplexing and channel coding”, version 17.4.0). Here, the network node 200 might define a report asking for measurements on synchronization signal blocks (SSBs) only since the SSBs are periodically transmitted, with the intention for the UE 130a to report only the strongest SSB (setting the parameter nrofReportedRS to 1 in aforementioned 3GPP TS 38.331). This can be made to ensure that the report does not hold too many information bits such that the coding somehow fails to fit one PRB.

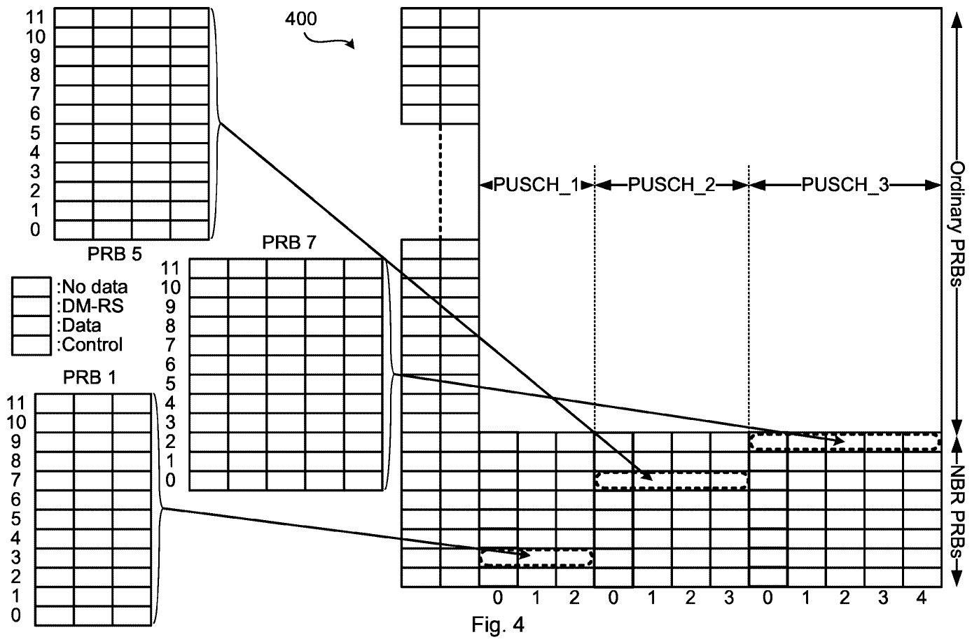

Further, for hybrid beamforming systems with many antennas, it may only be affordable to have a narrowband receiver (i.e., a digital receiver with limited bandwidth). Therefore, the UE 130 can be configured such that the DM-RSs are transmitted within the bandwidth of a narrowband receiver. That is, in some embodiments, the at least one DM-RS is in the network node 200 received by a narrowband receiver (NBR; where the narrowband receiver has a bandwidth and thus is configured to receive signals only within this bandwidth), and where the UE 130a is triggered to transmit the DM-RS with higher density within the bandwidth of the NBR than outside the bandwidth of the NBR. One example of how to organize as many PUSCH transmissions as possible to fit within the NBR bandwidth is illustrated in FIG. 4. FIG. 4 shows an example of a time/frequency resource grid 400 for one uplink slot composed of 14 orthogonal frequency-division multiplexing (OFDM) symbols extending over of 65 physical PRBs. In more detail, in FIG. 4 is illustrated how several PUSCH resources can be packed in an uplink slot within the NBR bandwidth. It is assumed that the NBR bandwidth only covers the lowest (first) 8 PRBs. In the illustrated example, one uplink slot is divided into three mini-slots, denoted by PUSCH_1, PUSCH_2 and PUSCH_3. In mini-slot PUSCH_1, DM-RSs are transmitted in PRB 1, whereas in mini-slot PUSCH_2, DM-RSs are transmitted in PRB 5, and in mini-slot PUSCH_3, DM-RSs are transmitted in PRB 7. In this way the network node 200 would obtain information from as many (non-sounding) UEs as possible.

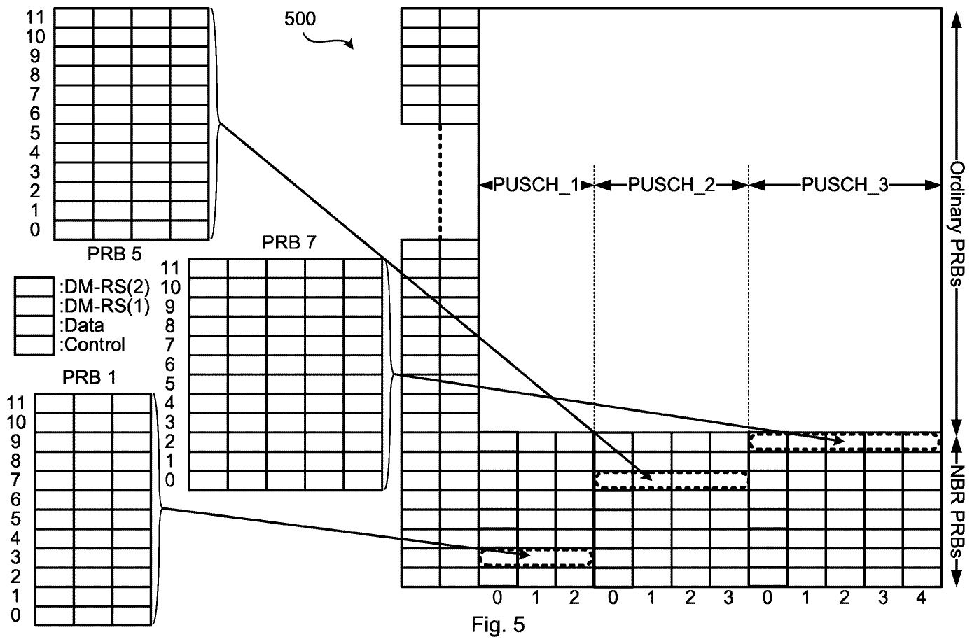

Moreover, several non-sounding UEs might be frequency-multiplexed on the same DM-RS symbol using the field ‘Antenna ports’ of the uplink DCI. The antenna ports are organized in code division multiplexing (CDM) groups, where each group is defined over its own subcarriers. That is, in some embodiments, at least two UEs 130a, 130b are triggered by the network node 200 to perform an uplink transmission that comprises the DM-RS, where each of the at least two UEs 130a, 130b is triggered to use DM-RS that are orthogonal to the DM-RS of other UE 130a, 130b with respect to frequency and code. For DM-RS type 1, every even subcarrier corresponds to a first CDM group and every odd subcarrier corresponds to a second CDM group. The first CDM group contains antenna ports 1000 and 1001; the second CDM group contains antenna ports 1002 and 1003. Within a CDM group, the antenna ports are differentiated based on CDM. An example of this multiplexing scheme is shown in the time/frequency resource grid of FIG. 5. Similar to FIG. 4, in FIG. 5 is shown an example of a time/frequency resource grid 500 for one uplink slot composed of 14 OFDM symbols that extend over of 65 PRBs, where the NBR bandwidth only covers the lowest (first) 8 PRBs, and where the uplink slot is divided into three mini-slots, denoted by PUSCH_1, PUSCH_2 and PUSCH_3. Further, in FIG. 5 is illustrated how several (non-sounding) UEs can be assigned different antenna ports such that their DM-RS can be differentiated based on frequency and code. In this respect, DM-RS(1) denotes the DM-RSs for CDM Group 0 (Antenna Port 1000/1001) whereas DM-RS(2) denotes the DM-RSs for CDM Group 1 (Antenna Port 1002/1003). For instance, in FIG. 5 in PUSCH_1 can four UEs can be multiplexed on the DM-RS symbol. This means that several UEs can be scheduled in the same PRB resources, assigning each of the UEs different antenna ports in the DCI. Table 7.3.1.1.2-8 in aforementioned 3GPP TS 38.212 provides one example of this. That several UEs transmits on PUSCH using the same resource elements does not matter if the network node 200 does not have to decode any payload. This is since the DM-RS resources are orthogonal with respect to frequency and code.

Further aspects of where the UE 130a is allowed to transmit user data even when the UE 130a has been explicitly triggered to perform an uplink transmission that comprises DM-RSs will be disclosed next.

In this case the network node 200 performs full decoding of the PUSCH to ensure alignment between the network node 200 and the UE 130 with respect to user data transfer. Here, it could be that the UE 130a does not have any user data to transmit. However, using RRC configuration the network node 200 can instruct the UE 130a whether to send nothing or to send padding. That is, in some embodiments, the UE 130a is triggered to use PUSCH signaling with padding when transmitting the DM-RS. The relevant RRC settings are skipUplinkTxDynamic or enhancedSkipUplinkTxDynamic (set as true for no transmission, and false for padding) as stated in aforementioned 3GPP TS 38.331. Padding can be used to ensure that the PUSCH transmission at least includes DM-RS.

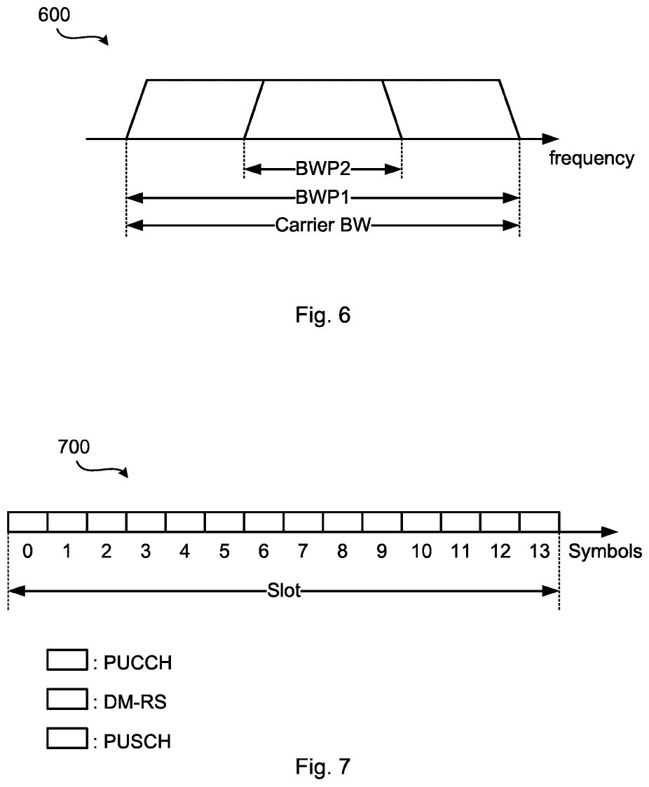

In general terms, for the quality of the beam estimation based on the DM-RSs to be as good as possible, the uplink transmission from the UE 130a should contain as many DM-RSs as possible. To still have uplink transmissions with nominal density of the DM-RSs, a special bandwidth part identifier (BWP-Id) representing a configuration with a dense configuration of DM-RSs can be used for non-sounding UEs 130a whenever sounding is required by the network node 200. That is, in some embodiments, the UE 130a is triggered to transmit the DM-RS at least within a BWP as signaled by the network node 200 in a BWP identifier in a DCI element. For sounding UEs 130b the network node 200 does not need to change the BWP Id but can use a default configuration. Switching of BWP-Id from a default configuration for non-sounding UEs 130a can be done dynamically on a DCI level using the Bandwidth Part Indicator parameter (see, 3GPP TS 38.212 “NR; Multiplexing and channel coding”, version 17.4.0, Table 7.3.1.1.2-1) in DCI format 0_1; it does not require RRC reconfiguration, and thus it is a fast procedure. Reference is here made to FIG. 6 in which is shown an example spectrum 600 with two BWPs; BWP1 and BWP2 extending along a carrier bandwidth (BW). BWP1 corresponds to the BWP used by a sounding UE 130b whereas BWP2 corresponds to the BWP used by a non-sounding UE 130a, respectively. In this respect, the non-sounding UE 130a might use both BWP1 and BWP2, depending on its need, but only use BWP2 when triggered (as in S104) to transmit DM-RS (as received by the network node 200 in S106).

Another way of exploiting DM-RS resources is to select DM-RS configurations such that PUSCH contains one DM-RS symbol per direction 270 induced by the analog beamforming. That is, in some embodiments, the UE 130a is triggered to transmit the DM-RS according to a schedule for the network node 200 to receive at least one of the DM-RS in each direction induced by the analog beamforming. In this way, the network node 200 can cope with mobility of the UE 130a. By applying a specific direction at reception of a certain DM-RS resource it does not matter in which of the directions the UE 130a is located in. This enables accommodating many UEs within the bandwidth of the narrowband receiver, regardless of which direction the UE resides in. A typical configuration for one UE in this case is illustrated in FIG. 7 which shows 14 OFDM symbols, extending over a slot 700, where there are three DM-RS symbols, two PUCCH symbols, and nine PUSCH symbols distributed among the 14 OFDM symbols. Hence, such a configuration could be used in case three directions induced by analog beamforming are deployed.

An alternative approach is to trigger the UE 130a to transmit the DM-RSs using physical uplink control channel (PUCCH) signaling. That is, in some embodiments, the UE 130a is triggered by the network node 200 to transmit the DM-RS using PUCCH signaling. One example is to utilize a hybrid automatic repeat request (HARQ) process to trigger the UE 130a to provide feedback (in terms of a negative acknowledgement NACK) that comprises DM-RSs. That is, in some embodiments, the UE 130a is triggered to transmit the DM-RS by the network node 200, in a HARQ process, scheduling a downlink grant for the UE 130a without the network node 200 transmitting any user data towards the UE 130a for the DM-RS to be transmitted in a NACK message using the PUCCH signaling. In further detail, the network node 200 might use physical downlink control channel (PDCCH) signaling to schedule a downlink grant for the UE 130a but without transmitting any physical downlink shared channel (PDSCH) signaling for the UE 130a. This will trigger the UE 130a to transmit a NACK message on the PUCCH. The unused resources of the PDSCH scheduled by the PDCCH can be used by the network node 200 for another UE.

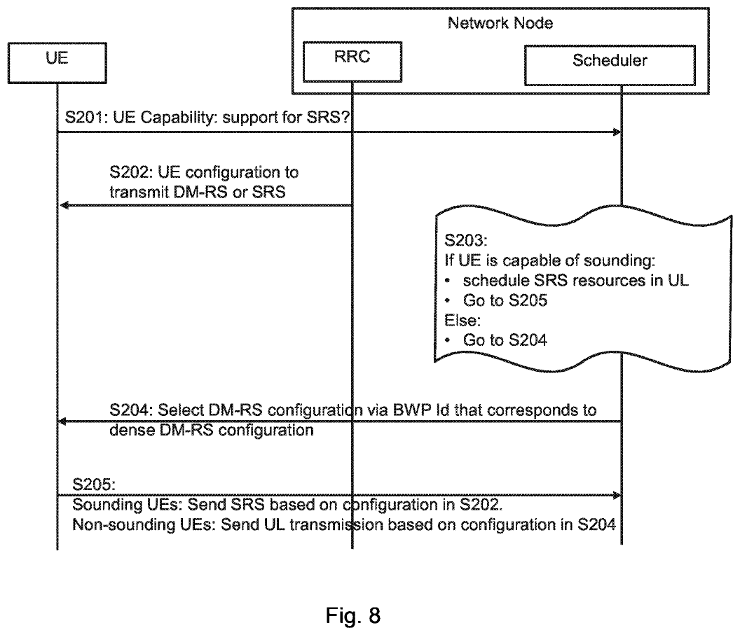

One particular embodiment for determining a serving beam for a UE 130a as based on at least some of the above disclosed embodiments will be disclosed next with reference to the signaling diagram of FIG. 8.
S201: Acquiring UE capability information. The network node 200 acquires UE capability information from each of the UEs 130a, 130b in order to determine if the UEs are capable of performing sounding or not. It is hereinafter assumed that UE 130a is a non-sounding UE 130a whereas UE 130b is a sounding UE 130b.
S202: UE-specific RRC configuration for non-sounding UE 130a and SRS configuration for sounding UEs 130b. In order to accommodate both the non-sounding UE 130a and the sounding UE 130a, the network node 200 performs necessary configuration on RRC level to avoid RRC reconfiguration during runtime. In this way the control for switching between these configurations can be passed to lower protocol layers.
S203: UE sounding capability check. SRS resources are scheduled for the sounding UE 130b. Step S205 is then entered for the sounding UE 130b. Step S204 is entered directly for the non-sounding UE 130a.
S204: Selection of DM-RS configuration for non-sounding UE 130a. The network node 200 selects a dense DM-RS configuration for the non-sounding UE 130a, and provides this configuration via an BWP Id in DCI to the non-sounding UE 130a. Further, the non-sounding UE 130a is triggering to perform an uplink transmission that comprises the configured DM-RSs.
S205: Sounding process. The non-sounding UE 130a performs an uplink transmission that comprises the configured DM-RSs. The network node 200 receives the DM-RSs in different beams and selects the beam in which the DM-RSs were received with highest received power to be used for upcoming transmission/reception for the non-sounding UE 130a. The sounding UE 130b performs uplink transmission that comprises the configured SRS resources. The network node 200 receives the SRS resources in different beams and selects the beam in which the SRS resources were received with highest received power to be used for upcoming transmission/reception for the sounding UE 130b.

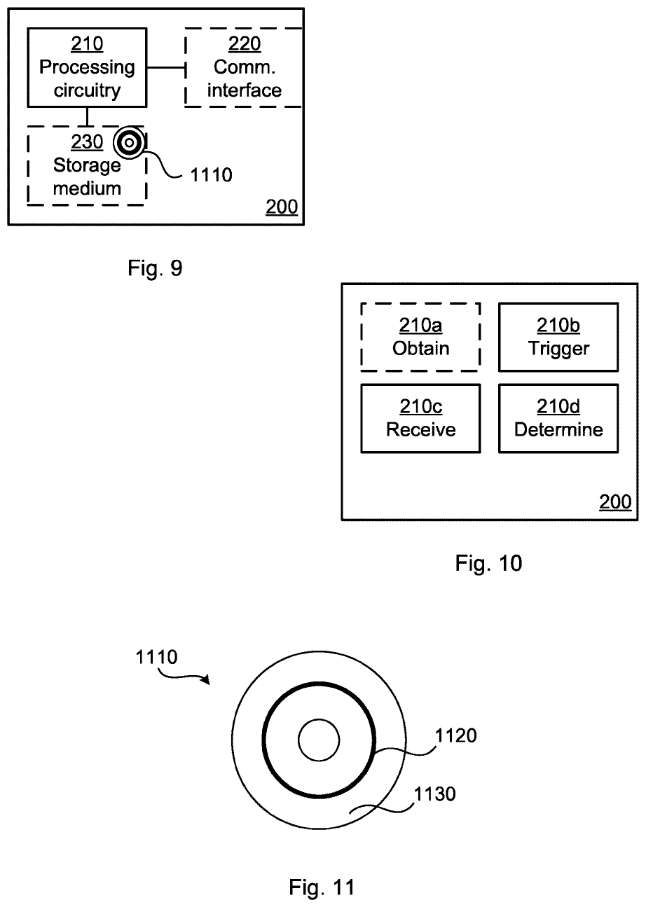

FIG. 9 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1110 (as in FIG. 11), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or steps, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The network node 200 may further comprise a communications (comm.) interface 220 at least configured for communications with other entities, functions, nodes, and devices, as illustrated in FIG. 2. As such the communications interface 220 may comprise one or more transmitters and receivers, comprising analogue and digital components. The processing circuitry 210 controls the general operation of the network node 200 e.g. by sending data and control signals to the communications interface 220 and the storage medium 230, by receiving data and reports from the communications interface 220, and by retrieving data and instructions from the storage medium 230. Other components, as well as the related functionality, of the network node 200 are omitted in order not to obscure the concepts presented herein.

FIG. 10 schematically illustrates, in terms of a number of functional modules, the components of a network node 200 according to an embodiment. The network node 200 of FIG. 10 comprises a number of functional modules; a trigger module 210b configured to perform step S104, a receive module 210c configured to perform step S106, and a determine module 210d configured to perform step S108. The network node 200 of FIG. 10 may further comprise a number of optional functional modules, such as an obtain module 210a configured to perform step S102. In general terms, each functional module 210a:210d may in one embodiment be implemented only in hardware and in another embodiment with the help of software, i.e., the latter embodiment having computer program instructions stored on the storage medium 230 which when run on the processing circuitry makes the network node 200 perform the corresponding steps mentioned above in conjunction with FIG. 10. It should also be mentioned that even though the modules correspond to parts of a computer program, they do not need to be separate modules therein, but the way in which they are implemented in software is dependent on the programming language used. Preferably, one or more or all functional modules 210a:210d may be implemented by the processing circuitry 210, possibly in cooperation with the communications interface 220 and/or the storage medium 230. The processing circuitry 210 may thus be configured to from the storage medium 230 fetch instructions as provided by a functional module 210a:210d and to execute these instructions, thereby performing any steps as disclosed herein.

The network node 200 may be provided as a standalone device or as a part of at least one further device. For example, the network node 200 may be provided in a node of a radio access network or in a node of the core network. Alternatively, functionality of the network node 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the network node 200 may be executed in a first device, and a second portion of the of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 9 the processing circuitry 210 may be distributed among a plurality of devices, or nodes. The same applies to the functional modules 210a:210d of FIG. 10 and the computer program 1120 of FIG. 11.

Some (radio) access network architectures define network nodes (or gNBs) comprising multiple component parts or nodes: a central unit (CU), one or more distributed units (DUs), and one or more radio units (RUs). The protocol layer stack of the network node is divided between the CU, the DUs and the RUs, with one or more lower layers of the stack implemented in the RUs, and one or more higher layers of the stack implemented in the CU and/or DUs. The CU is coupled to the DUs via a fronthaul higher layer split (HLS) network; the CU/DUs are connected to the RUs via a fronthaul lower-layer split (LLS) network. The DU may be combined with the CU in some embodiments, where a combined DU/CU may be referred to as a CU or simply a baseband unit. A communication link for communication of user data messages or packets between the RU and the baseband unit, CU, or DU is referred to as a fronthaul network or interface. Messages or packets may be transmitted from the network node 200 in the downlink (i.e., from the CU to the RU) or received by the network node 200 in the uplink (i.e., from the RU to the CU).

FIG. 11 shows one example of a computer program product 1110 comprising computer readable storage medium 1130. On this computer readable storage medium 1130, a computer program 1120 can be stored, which computer program 1120 can cause the processing circuitry 210 and thereto operatively coupled entities and devices, such as the communications interface 220 and the storage medium 230, to execute methods according to embodiments described herein. The computer program 1120 and/or computer program product 1110 may thus provide means for performing any steps as herein disclosed.

In the example of FIG. 11, the computer program product 1110 is illustrated as an optical disc, such as a CD (compact disc) or a DVD (digital versatile disc) or a Blu-Ray disc. The computer program product 1110 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1120 is here schematically shown as a track on the depicted optical disk, the computer program 1120 can be stored in any way which is suitable for the computer program product 1110.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for determining a serving beam for a user equipment, UE, wherein the method is performed by a network node and wherein the method comprises:
triggering the UE to perform an uplink transmission that comprises a demodulation reference signal, DM-RS;
receiving, in a set of beams, the DM-RS from the UE; and
determining, based on channel state measurements performed by the network node on the DM-RS as received in the set of beams, which beam in the set of beams to use as the serving beam for the UE.

2. The method according to claim 1, wherein the method further comprises:
obtaining an indication that the UE at least momentarily is incapable of transmitting a sounding reference signal, SRS.

3. The method according to claim 2, wherein the indication is obtained in UE capability signaling from the UE.

4. The method according to claim 1, wherein the UE is triggered to periodically perform the uplink transmission that comprises the DM-RS.

5. The method according to claim 1, wherein the UE is triggered by dynamic scheduling, provided by the network node via physical downlink control channel, PDCCH, signaling, to periodically perform the uplink transmission that comprises the DM-RS.

6. The method according to claim 1, wherein the UE is triggered by a configured uplink grant, provided by the network node via radio resource control, RRC, signaling, to periodically perform the uplink transmission that comprises the DM-RS.

7. The method according to claim 1, wherein the DM-RS are in the network node received by a narrowband receiver, NBR, having a bandwidth, and wherein the UE is triggered to transmit the DM-RS with higher density within the bandwidth of the NBR than outside the bandwidth of the NBR.

8. The method according to claim 1, wherein the UE is triggered to transmit the DM-RS at least within a bandwidth part, BWP, as signaled by the network node in a BWP identifier in a downlink control information, DCI, element.

9. The method according to claim 1, wherein the UE is triggered to transmit the DM-RS according to a schedule for the network node to receive at least one of the DM-RS in each direction as induced by analog beamforming.

10. The method according to claim 1, wherein the UE is triggered by the network node to transmit the DM-RS using physical uplink shared channel, PUSCH, signaling.

11. The method according to claim 10, wherein the UE is triggered to perform a transmission of a channel state information, CSI, report, wherein the transmission is without user data but comprises the DM-RS.

12. The method according to claim 10, wherein the PUSCH signaling comprises payload, and wherein the network node ignores decoding the payload.

13. The method according to claim 10, wherein at least two UEs are triggered by the network node to perform an uplink transmission that comprises the DM-RS, and wherein each of the at least two UEs is triggered to use DM-RS that are orthogonal to the DM-RS of other UE with respect to frequency and code.

14. The method according to claim 10, wherein the UE is triggered to use PUSCH signaling with padding when transmitting the DM-RS.

15. The method according to claim 1, wherein the UE is triggered by the network node to transmit the DM-RS using physical uplink control channel, PUCCH, signaling.

16. The method according to claim 15, wherein the UE is triggered to transmit the DM-RS by the network node, in a hybrid automatic repeat request, HARQ, process, scheduling a downlink grant for the UE without the network node transmitting any user data towards the UE for the DM-RS to be transmitted in a negative acknowledgement, NACK, message using the PUCCH signaling.

17. A network node for determining a serving beam for a user equipment, UE, the network node comprising processing circuitry, the processing circuitry being configured to cause the network node to:
trigger the UE to perform an uplink transmission that comprises a demodulation reference signal, DM-RS;
receive, in a set of beams, the DM-RS from the UE; and
determine, based on channel state measurements performed by the network node on the DM-RS as received in the set of beams, which beam in the set of beams to use as the serving beam for the UE.

18. A network node for determining a serving beam for a user equipment, UE, the network node comprising:
a trigger module configured to trigger the UE to perform an uplink transmission that comprises a demodulation reference signal, DM-RS;
a receive module configured to receive, in a set of beams, the DM-RS from the UE; and
a determine module configured to determine, based on channel state measurements performed by the network node on the DM-RS as received in the set of beams, which beam in the set of beams to use as the serving beam for the UE.

19. The network node according to claim 17, further being configured to obtain an indication that the UE at least momentarily is incapable of transmitting a sounding reference signal, SRS.

20. A computer program for determining a serving beam for a user equipment, UE, the computer program comprising computer code which, when run on processing circuitry of a network node, causes the network node to:
trigger the UE to perform an uplink transmission that comprises a demodulation reference signal, DM-RS;
receive, in a set of beams, the DM-RS from the UE; and
determine, based on channel state measurements performed by the network node on the DM-RS as received in the set of beams, which beam in the set of beams to use as the serving beam for the UE.

21. (canceled)
